(19) United States
(12) Patent Application Publication
(10) Pub. No.: US 2008/0046115 A1
(43) Pub. Date: Feb. 21, 2008

(54) Method and Device for Checking the Loading of a Transport Device with Objects

(75) Inventors: Wolfgang Tabellion, Ralingen (DE); Martin Hammen, Trier (DE)

Correspondence Address: FLETCHER YODER, P.O. BOX 692289, HOUSTON, TX, 77269-2289, US

(73) Assignee: DEUTSCHE POST AG, 53113 Bonn (DE)

(21) Appl. No.: 11/666,100

(22) PCT Filed: Oct. 24, 2005
(86) PCT No.: PCT/EP05/11386

§ 371 Date: Sep. 25, 2007

(30) Foreign Application Priority Data
Oct. 25, 2004 (DE) 10 2004 051 938.2

(51) Int. Cl. G06F 7/00

(52) U.S. Cl. 700/226

(57) ABSTRACT

The disclosure relates to a system and method for checking the loading of a transport device, the transport device being adapted to be loaded with one or more objects that each have an optically detectable identifier that is adapted to store at least information about a destination of the respective object. An exemplary method comprises detecting a destination of the transport device, moving the transport device, together with the one or more objects, past a scanning device that is adapted to detect the information stored on the identifiers of the objects, the scanning device having at least two scanners arranged one above the other, detecting a loading height of the objects when the transport device is moved past the scanning device, detecting the destination of the one or more objects from their respective identifiers, comparing the detected destination of each of the one or more objects with the destination of the transport device, comparing the detected loading height to previously stored information about the sizes of the objects corresponding to the identifiers scanned by the scanning unit, generating a first signal if the destination of any object does not match the destination of the transport device, and generating a second signal in case a plausibility check reveals that an object with an unreadable identifier or with no identifier at all is positioned in an area of the transport device.

The invention relates to a method for checking the loading of a transport device, whereby the transport device is loaded with one or more objects. The objects are provided with an identification means, whereby at least information about the destination of the object in question is stored in the identification means.

The invention also relates to a device for carrying out a method for checking the loading of a transport device.

In the collection and shared transportation of objects, it is a known procedure to provide each of the objects with an identification means in which, along with information about the object, the destination of the object is also stored. This type of identification is found, for example, in logistics or shipping systems or in the area of picking goods. Barcodes or RFID transponders, for example, are known as identification means.

Particularly in postal operations, containers used for transporting mailpieces are provided with an information carrier that can contain various pieces of information such as the content of the container, the format of the mailpiece, the processing modality, the next processing machine or a next mail center. This information is applied in the form of printed plain text for purposes of visual recognition by personnel and is augmented by a barcode in which the information—optionally together with additional information—is encrypted. Transport devices such as container carts are normally provided with information carriers that can likewise have a barcode.

During the transportation of the containers with the mailpieces, the information carriers on the containers are read and scanned in or out in the individual processing modules. This is done mainly for controlling the containers, for production analysis and for statistical purposes. Since the information carriers contain information about the destination of a container, the utilization of this information is also well-suited for checking the loading of transport carts onto which several containers having the same destination are loaded. If containers are placed onto different container carts by personnel in such a way as to be sorted according to destination, it can happen that a container is placed onto the wrong cart and is thus transported to the wrong destination. Since the transportation time of multiple mailpieces to their correct destination is considerably prolonged by such errors, efforts are made in postal operations to prevent such cases from occurring.

One way to avoid the occurrence of wrong destinations is for personnel to visually check the container destinations or to scan in the barcodes of all of the containers. However, a visual inspection of the printed plain text of an information carrier is not only time-consuming but also error-prone, and the individual scanning of the barcodes involves much more effort.

Consequently, solutions are known in various areas of logistics for checking transport destinations or contents of containers with which identification means associated with such containers are detected and compared to target values. For example, German utility model DE 202 00 411 U1 describes a device used in a picking system for recognizing and controlling bulk goods that have been provided with a code. Here, the bulk goods are equipped with transponders and are conveyed one after the other on a conveyor belt through a scanning tunnel, whereby the code stored in the transponder is detected and compared to target data. However, it takes a great deal of technical effort to implement such a system with transponders for transport carts on which several containers are stacked next to and above each other. Moreover, in this manner, it cannot be recognized if a transponder is not functioning properly, resulting in high error rates.

German preliminary published application DE 102 09 864 A1 discloses a method and a device for recognizing and controlling bulk goods that have been provided with a code, with which method the goods picked and placed into a container are removed from the container, segregated and fed in a centered position through a scanning tunnel. The bulk goods are provided with barcodes that are detected inside the scanning tunnel by several scanners distributed along the circumference of the tunnel. The acquired data is compared to stored target data of the appertaining container.

German patent specification DE 39 00 978 C2 discloses a device for identifying objects moving along a course, in which method the objects are provided with an information carrier having several rows of openings one above the other. In order to recognize the object, the information carrier is moved past a reading device with three light barriers, which are likewise arranged one above the other, so that the light barriers can scan the hole markings.

The objective of the invention is to provide a method for checking the loading of a transport device with objects, whereby it is checked whether the destination of all of the loaded objects matches the destination of the transport device. In particular, the method is to be suitable for checking transport carts with several containers that each hold mailpieces for a shared destination.

The objective of the invention is also to provide a device for carrying out the method.

According to the invention, this objective is achieved by a method having the features of the independent Claim 1. Advantageous refinements of the method are set forth in the subordinate Claims 2 through 24. The objective is also achieved by a device according to Claim 25. Advantageous embodiments of the device are likewise set forth in the subordinate Claims 26 through 31.

Several steps are provided in the method according to the invention for checking the loading of a transport device, in which method the transport device is loaded with one or more objects and the objects are provided with a preferably optically detectable identification means, whereby in an especially preferred embodiment, all of the identification means face in the same direction and at least information about the destination of each object is stored in the identification means. These steps include detecting the destination of the transport device and moving the transport device, together with the objects, past a scanning device, whereby the scanning device detects the identification means with at least two scanners arranged one above the other. In order to be able to detect the identification means preferably optically with the scanners, the transport device is configured so as to be open on at least one side or else to have openings through which the beams of the scanner can pass.

As an alternative, detection with electromagnetic radiation of a different wavelength spectrum is possible, for example, with UV, IR or radio frequencies; this is especially applicable if transponders are used.

The detected information of the identification means is transmitted to an evaluation unit where it is evaluated, whereby the destination contained in the identification means is ascertained. The detected destination of each object is compared to the destination of the transport device and a first signal A is generated by the evaluation unit if the destination of an object detected with an identification means does not match the destination of the transport device.

The first signal A of the evaluation unit is preferably converted into information that can be perceived by a user, whereby this can be, for example, an acoustic signal and/or a visual display on a display device. The evaluation unit also generates information indicating which object has an identification means containing a destination that does not match the destination of the transport device. This information is preferably displayed visually on a display device.

In order to detect the destination of the transport device, in an especially preferred embodiment of the invention, said transport device is associated with another identification means in which the destination of the transport device is stored. This identification means is detected by a portable scanner before or after being moved past the scanning device or else automatically by a separate scanner while being moved past the scanning device. The destination of the transport device can also be entered manually by a user before or after each time the transport device is moved past the scanning device or else said destination is permanently stored in the evaluation unit.

In an especially preferred embodiment, the method according to the invention is augmented by additional advantageous features. For example, the loading height of the objects is additionally detected when the transport device with the objects is moved past the scanning device, whereby the scanning device scans the objects with at least two light barriers arranged one above the other. The information about the detected loading height is likewise transmitted to the evaluation unit and compared to information present in the evaluation unit about the sizes of the objects belonging to the identification means. In case a plausibility check reveals that an object with an unreadable identification means or with no identification means at all is positioned in an area of the transport device, then the evaluation unit generates a second signal B.

The second signal B is also converted into information that can be perceived by a user, indicating that an object with an unreadable identification means or with no identification means at all is positioned in an area of the transport device. The evaluation unit also generates information indicating in which area of the transport device an object is present with an unreadable identification means or with no identification means at all and this information is displayed on a display device.

The objects to be checked are preferably containers and the transport device is preferably a container cart on which several containers are stacked. When the method according to the invention is used in postal operations, the containers are typically those holding mailpieces having the same transport destination. The objects can be of different sizes, whereby the identification means contain information about size of the individual objects and the information about the size detected by the scanning device is transmitted to the evaluation unit and processed there. If all of the objects are of the same size, the size can be entered into the evaluation unit and stored there.

In another especially preferred embodiment of the invention, the scanning device is blocked for further operation once a signal has been generated by the evaluation unit indicating that a destination of an object detected by an identification means does not match the destination of the transport device and/or indicating that an object with an unreadable identification means or with no identification means at all is positioned in an area of the transport device. Various methods can be provided in order to unblock the device. For example, the unblocking of the scanning device can require a manual input by a user or else the transport device that has been identified as being incorrectly loaded has to be moved past the scanning device once again.

The evaluation unit advantageously creates a protocol about the signals A and B, and the information acquired by the scanning device about the destinations of the objects or of the transport device is transmitted to a central administration system.

The invention also comprises a device for carrying out a method for checking the loading of a transport device that is open on at least one side, whereby the transport device is loaded with one or more objects and the objects are provided with an optically detectable identification means. The device has a scanning device with a housing in which several scanners are positioned one above the other. The device also comprises a means for detecting the destination of a transport device, whereby the means is connected to the evaluation unit. The means for detecting the destination can be a separate scanner that is located on the housing. The means can also be configured as a portable component separate from the housing.

In order to evaluate the signals detected by the scanners, the evaluation unit comprises computing means for comparing the detected destinations of the objects to the destination of the transport device and also comprises alarm means to generate a first signal A in case the comparison has revealed that a detected destination of an object does not match the destination of the transport device.

In an especially preferred embodiment of the invention, the device also comprises several light barriers arranged one above the other, whereby the number of light barriers at least matches the number of scanners. Moreover, means with which the size of an object can be detected and computing means with which a loading height of the objects detected with the light barriers can be compared to the size of the detected objects are provided. Moreover, the device comprises alarm means for generating a second signal B in case the comparison has revealed that a detected object has an unreadable identification means or no identification means at all.

The scanning device is advantageously connected to a display device and the evaluation unit comprises computing means for ascertaining and displaying on the display device an object whose destination does not match the destination of the transport device and/or that has an unreadable identification means or no identification means at all.

Since a certain distance from the scanners must not be exceeded when a transport device with several objects is moved past the scanners of the scanning device, the scanning device has spacers for moving the transport device past, at a certain distance from the housing of the device. The spacers can be, for instance, an elongated collision guard that is arranged at a distance from the housing and along which the transport device can be pulled manually. In an alternative embodiment, two guide grooves at a distance from the housing are used as the spacers, and the wheels of a transport cart are manually pulled through said grooves when the method is being carried out.

The advantage of the method according to the invention and of the appertaining device for carrying out the method lies in the effective and reliable checking of the loading of a transport device with objects, whereby the method can ascertain and display various incorrect loads. In addition to the information that an incorrect object was loaded, a user also receives the information as to which object is the culprit so that he can systematically remove the object. Here, not only objects with incorrect destinations are displayed but various embodiments of the method according to the invention also make it possible to ascertain that an object has an unreadable identification means in the form of a barcode or no identification means at all. Thus, for example, damaged information carriers of a container can be replaced before they cause more errors when the container is transported further.

With the method according to the invention, a large number of objects can be checked simultaneously so that the individual scanning of identification means is replaced by an efficient and reliable method for checking loads of transport devices.

Additional advantages, special features and practical refinements of the invention can be gleaned from the subordinate claims and from the presentation below of preferred embodiments making reference to the figures.

The figures show the following:

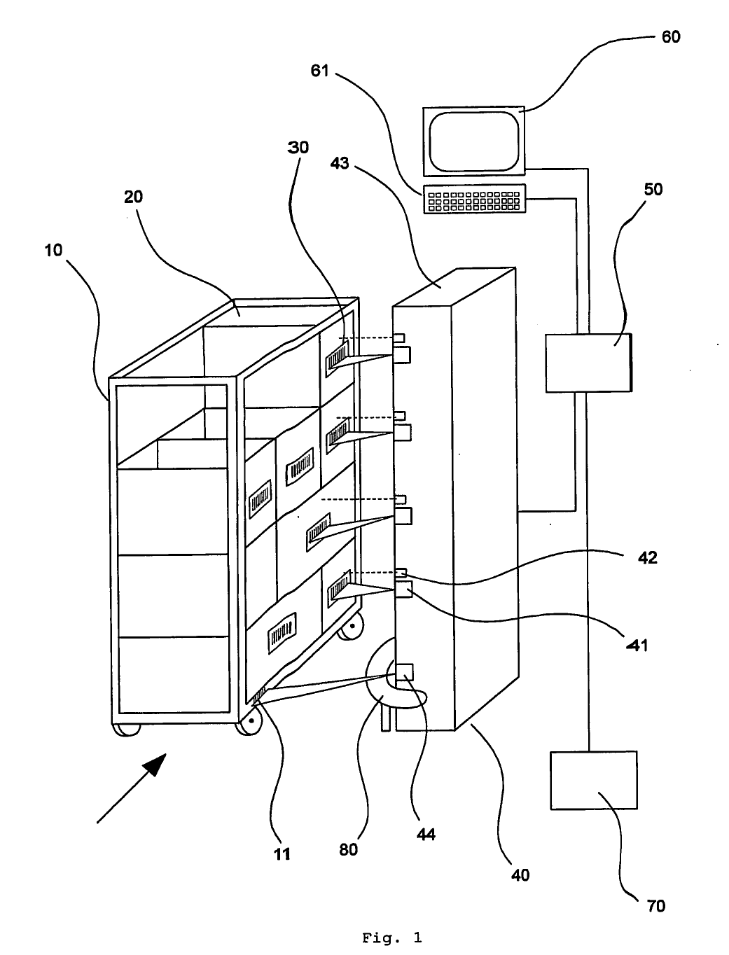

FIG. 1 an especially preferred embodiment of a device for checking the loading of a transport device with objects; and

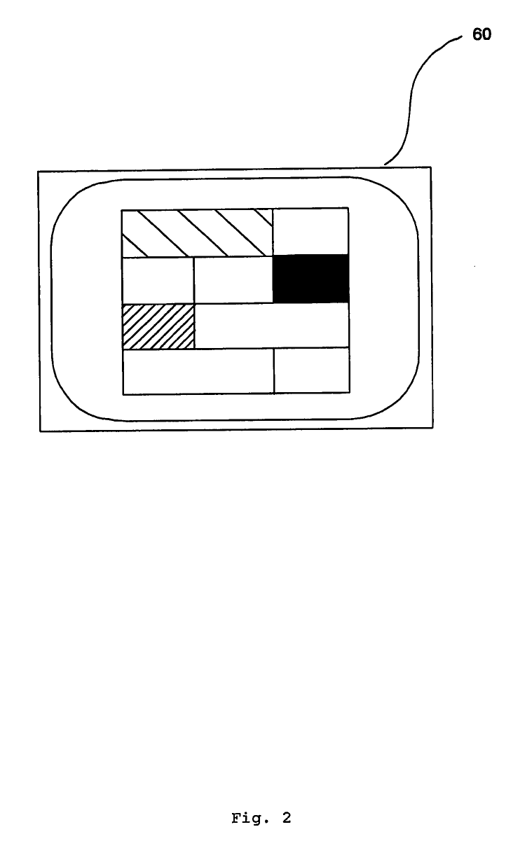

FIG. 2 an embodiment of a display of the checking result on a display device.

FIG. 1 shows an especially preferred embodiment of the device according to the invention for checking the loading of a transport device. The method according to the invention with its various advantageous embodiments is likewise described on the basis of this FIG. 1.

The device is a scanning device 40 that consists essentially of a housing 43 with elements mounted in it. The device can be configured as a free-standing device or it can be integrated into other devices. On at least one side of the scanning device, several scanners 41 are arranged one above the other in the housing 43. In order to enhance the capacity utilization and flexibility of the device, scanners can be installed on both sides of the device so that the transport devices that are to be checked can be moved past on both sides.

The scanners 41 are preferably installed at a height that corresponds to the anticipated height of an identification means 30 on an object 20. In the embodiment shown, the objects 20 are containers that are stacked above each other and next to each other on a transport cart 10. The containers can be of different sizes so that one scanner is provided for each possible vertical position of an identification means. The number of scanners depends on the maximum number of barcodes arranged one above the other that are to be detected.

It has proven to be advantageous to likewise provide the transport cart 10 with an identification means 11. In the embodiment shown here, this identification means is located at the bottom of the transport cart so that a separate scanner 44 is provided at this height in the lower section of the scanning device. The identification means 11 of the transport device can also be installed in other areas of the transport device that can only be accessed, for example, by a portable hand-held scanner. In this case, the additional scanner is not integrated into the housing but rather, for example, configured as a hand-held scanner, so that an operator can manually scan in the identification means 11 of the transport device. Here, the hand-held scanner is connected to the scanning device 40 for purposes of data transmission.

The identification means employed for marking the containers and the transport device are advantageously barcodes. The barcodes can be permanently affixed to each object, or else they are printed onto an information carrier of the type commonly used in postal operations. The information carrier is detachably affixed to the container, which can be achieved, for instance, by sliding it into a side wall of the container. Depending on the use of the container, during every subsequent transporting or processing step, a new information carrier with a new barcode is slid into the side wall of the container. In addition to comprising a barcode, the information carrier also contains additional information in plain text.

At least the next destination of the container is encrypted and stored in the barcode of an identification means 30 of a container 20. Particularly in postal operations, the destination can be the next processing station or a mail center. In addition to the destination, other information can also be encrypted such as, for example, the format of the mailpieces sorted in a container, the size of the container and/or a container ID. At least the destination of the transport device is likewise stored in the barcode of an identification means 11 of a transport device 10. In addition to the destination, additional information such as, for example, an inventory number can also be stored here.

The scanners 41 employed are preferably LCD scanners, but other scanners can also be used. Suitable scanners and methods for detecting a movable barcode are known from the state of the art. The scanners are configured and arranged in such a way that they are situated at the height of a barcode that is to be detected. Slight deviations in the position of a barcode that can occur, for example, if the information carriers have slipped or if the containers are not precisely stacked, however, can be compensated for by using suitable scanners.

In order to ensure an error-free detection of several barcodes, a certain speed must not be exceeded when a barcode is being moved past a scanner. With the method according to the invention, it has proven to be advantageous not to exceed speeds of 1 meter per second. Moreover, a certain distance between the identification means and the scanners must not be exceeded. With the scanners shown in the embodiment, typical distances are in the order of magnitude of 10 cm to 20 cm.

If it is provided for the transport devices 10 to be moved past the scanning device manually, it is necessary to provide means for controlling the parameters of speed and distance. For this purpose, in an especially preferred embodiment of the invention, an elongated collision guard is provided as the spacer 80, which extends in front of the scanning device. The collision guard is configured as a bumper, whereby the outer edge of this arrangement is positioned at a distance from the scanners that allows the detection of the barcodes. An operator is expected to pull the transport cart 10 along the collision guard in such a way that it can be moved as parallel to the outer edge as possible. Here, it is advantageous for the collision guard to have a rounded edge at its beginning in the direction of the scanning device so that the transport cart can first be guided along the curve and then along the straight section of the collision guard. This makes it possible to prevent a transport cart from being pushed against the collision guard at too big an angle, which would prevent it from being able to follow a trajectory that is parallel to the scanning device. The device in FIG. 1 has such a collision guard, but for the sake of clarity, the transport device 10 is shown at a distance from the collision guard.

The experience of the operator ensures that the stipulated maximum speed is observed. Preferably, the scanning device generates an acoustic or optical signal if the speed was exceeded and if the transport cart has to be moved past the scanning device once again.

In another embodiment of the invention, which is not shown in FIG. 1, two guide grooves are provided in the floor in front of the scanning device as the spacers 80. The wheels of a transport cart can be slid into the grooves so that the cart can be pulled along the scanning device at a certain distance. Here, too, the maximum speed can be controlled by the experience of the operator. Moreover, it is possible to hitch the transport cart onto a transport system that moves the cart past the scanning device at a certain distance and at a certain speed.

Since the invention is not only suitable for checking transport carts but also transport devices of any kind, different spacers can be provided in alternative embodiments. For example, the transport devices can be moved past the scanning device on a separate conveying installation. This can be the case, for example, for loaded pallets that are placed onto a continuous conveyor belt and are moved past the device according to the invention. In this case, the maximum distance can easily be controlled by the position of the conveyor belt and the speed can be controlled by the advancing of the conveyor belt. In another embodiment, pallets can be moved past the device by means of a fork lift.

A light barrier 42 is preferably associated with each of the scanners 41 that are arranged one above the other. The light barriers are advantageously each located near a scanner, whereby the distance should not exceed the maximum distance of a barcode to the upper edge of a container. In this manner, it is ensured that a detected loading height can be associated directly with a container located below.

The scanning device 40 is connected to an evaluation unit 50 that processes the signals detected by the scanners 41, 44 and by the light barriers 42. The evaluation unit can be located inside the housing 43 or separate from it. The evaluation unit 50 has conventional computing means such as a processor and a memory. A program is stored in the evaluation unit and this program allows the processing of the detected signals into information indicating whether a transport device was loaded correctly. The evaluation unit is preferably connected to a display device 60 for displaying the result of the checking. This can be, for example, a monitor. Moreover, the evaluation unit can be connected to an input means 61 that can be a keyboard or a touchscreen.

In an especially preferred embodiment of the invention, in addition to the checking as to whether the destinations of the detected containers match the destination of the transport device, the checking of the loading of a transport device 10 also comprises checking whether all of the containers have a readable information carrier. Furthermore, it is also possible to check whether the maximum loading height of the transport device has been exceeded.

As an essential step for this purpose, the method according to the invention comprises the detection of the destination of the transport device. This detection can be carried out in various ways. If, for example, several transport devices with the same destination are to be checked, the shared destination can be permanently stored in the evaluation unit, which can be done, for example, by manual entry. Variable transport destinations can also be entered manually before each checking procedure. However, it has proven to be advantageous to also use an identification means in the form of a barcode in order to detect the transport destination. The identification means 11 used for this purpose is preferably affixed to the transport device and can be read in automatically by means of a separate scanner 44 at this height or else manually by means of a hand-held scanner.

According to the invention, a transport cart 10 with the containers 20 can be moved past the scanning device 40, taking the above-mentioned parameters of distance and speed into account, and the scanners 41 and the light barriers 42 then detect the loading status of the cart. Here, a cart is loaded in such a way that all of the identification means face in the same direction. In order to be able to check larger transport devices on which containers with identification means are placed that face in both directions, a second scanning device could be provided so that the transport cart is moved through a gate. The signals detected by the scanning device are transmitted to the evaluation unit 50 and processed there. In order to process the data, an essential prerequisite is that the evaluation unit needs information about the size of the individual container in question.

In cases where only containers of the same size are to be checked with the method, the size is advantageously stored in the evaluation unit. In an especially preferred embodiment of the invention, however, the device is configured in such a way that it can check containers of different sizes. In this case, the size of the containers 20 is stored in the appertaining identification means 30. This can be done, for example, indirectly via an entry about the type of container, whereby the size corresponding to a given type of container is stored in the evaluation unit. In particular, the evaluation unit has to contain the dimensions of the container side surfaces where the identification means are affixed.

A first step in the evaluation of the detected signals is that the detected destinations of the containers are compared to the destination of the transport device. If a destination does not match the destination of the transport device, then the evaluation unit generates a first signal A. The signal is preferably converted into a signal that can be perceived by a user. This can be, for example, an acoustic signal and/or a visual signal. In addition to the signal indicating that a container with a wrong destination was loaded, it is practical for the user to receive information as to which container is incorrect. This can be determined by the evaluation unit on the basis of the sequence of the signals and the height of the associated scanner. For this purpose, in a preferred embodiment of the invention, it is proposed that the container with the wrong destination be displayed on a monitor 60. The container can be displayed in such a way that an image of the transport cart with all of the containers is generated on the monitor and the wrong container is visually marked. For example, the container can be highlighted in red and an operator can check the wrong container and remove it. An example of the depiction of the checking result is shown in FIG. 2.

The method also proposes checking whether all of the containers have been provided with readable identification means. For this checking procedure, especially when containers of different sizes are used, the evaluation unit calculates the area occupied by the side wall of a specific container in the side view of the transport device. If no further barcode is detected in the calculated area, this is assessed by the evaluation unit as being correct. However, if the calculation shows areas that cannot be associated with any detected identification means, but in which the light barriers have detected an object, then the evaluation unit assesses this as being a case in which a container has an unreadable barcode or no barcode at all. Here, in particular, the loading height of the transport device detected by the light barriers is processed, since this allows the conclusion that containers must be present below the loading height. Uneven loading heights, for example, because several stacks of containers of different heights are arranged next to each other, can be detected by the light barriers and can be processed by the evaluation unit on the basis of the sequence and the position of the signals. If, for instance, a container is detected in the upper edge area of the stack, but if no matching barcode is detected, this means that at least one container without a readable barcode is located on the top of the stack.

Also in case of a non-detected barcode, the evaluation unit generates a second signal B that is displayed to the user in a preferably perceivable form. The area of the side view of the transport device thus identified is displayed on the monitor as a container with a missing information carrier, for example, in blue. An operator can now check the container and ascertain whether no information carrier is present or whether the barcode was merely not readable.

In another embodiment of the method, it is also possible to check whether a maximum permissible loading height has been being exceeded. This is possible by evaluating the signal of one of the upper light barriers that is positioned above the maximum loading height. If a container is detected in this area, this can likewise be displayed in color on the monitor.

It has proven to be advantageous to block the scanning device for further operation after an error signal of the evaluation unit. For the further use of the device, the scanning device has to be unblocked by a user. In the simplest case, the scanning device can be unblocked by a manual input by the user on an input means 61 such as a keyboard or a touchscreen. In this manner, the user has to react at least to the error message and push a prescribed key or enter a password. The password can also be entered by a third party who thereby authorizes the unblocking.

In another especially preferred embodiment, the unblocking takes place only after the transport device detected as being incorrect has once again been moved past the scanners and is found to have been corrected. For this purpose, the transport device has, for example, an identification means that, in addition to the destination, also comprises an unambiguous ID. The ID can be detected manually or automatically and compared to the most recently detected ID. If the identifications match and if the scanners and the light barriers then detect a transport device with containers, the evaluation unit evaluates the signals and, in the ideal case, does not issue an error message since the transport device should now be correctly loaded. If the identifications do not match or if no transport device is detected, then the evaluation unit does not issue a result and the device remains blocked for further operation.

Preferably, all of the procedures and especially the generation of error signals by the evaluation unit are logged. In another especially preferred embodiment of the invention, the data detected by the scanning device about error messages, about the destinations and/or about identifications of the containers is transmitted to a central administration system 70. The data can be processed in the administration system, for example, for purposes of ascertaining mail volumes, conducting statistical studies or carrying out an inventory of containers and transport carts. In particular, in the postal sector, information can be transmitted to a destination indicating how many and what type of mail containers are being transported to that destination.

### LIST OF REFERENCE NUMERALS

10 transport device, transport cart
20 object, container
30 identification means
40 scanning device
41 scanners, several
42 light barriers, several
43 housing
44 separate scanners, fixed/portable
50 evaluation unit
60 display device
61 input means, touchscreen, keyboard
70 central administration system
80 spacer, collision guard

1-31. (canceled)

32. A method for checking the loading of a transport device, the transport device being adapted to be loaded with one or more objects that each have an optically detectable identifier that is adapted to store at least information about a destination of the respective object, the method comprising:
detecting a destination of the transport device;
moving the transport device, together with the one or more objects, past a scanning device that is adapted to detect the information stored on the identifiers of the objects, the scanning device having at least two scanners arranged one above the other;
detecting a loading height of the objects when the transport device is moved past the scanning device;
detecting the destination of the one or more objects from their respective identifiers;
comparing the detected destination of each of the one or more objects with the destination of the transport device;
comparing the detected loading height to previously stored information about the sizes of the objects corresponding to the identifiers scanned by the scanning unit;
generating a first signal if the destination of any object does not match the destination of the transport device; and
generating a second signal if a plausibility check reveals that an object with an unreadable identifier or with no identifier at all is positioned in an area of the transport device.

33. The method according to claim 32, comprising converting the first signal into information that can be perceived by a user, indicating that the destination of at least one object does not match the destination of the transport device.

34. The method according to claim 33 wherein the information that can be perceived by the user is an acoustic signal and/or a visual display on a display device.

35. The method according to claim 32, comprising converting the second signal into information that can be perceived by a user, indicating that the object with the unreadable identifier or with no identifier at all is positioned in the area of the transport device.

36. The method according to claim 35 wherein the information that can be perceived by the user is an acoustic signal and/or a visual display on a display device.

37. The method according to claim 32, comprising generating information identifying which specific object has an identifier containing a destination that does not match the destination of the transport device.

38. The method according to claim 37, comprising displaying a visual indication identifying the object having an identifier containing the destination that does not match the destination of the transport device.

39. The method according to claim 32, comprising generating information identifying an area of the transport device that contains an object having an unreadable identifier or no identifier at all.

40. The method according to claim 39, comprising displaying a visual indication identifying the area of the transport device that contains the object having the unreadable identifier or no identifier at all.

41. The method according to claim 32, comprising associating the transport device with an identifier in which the destination of the transport device is stored, the identifier being detected by a portable scanner before or after being moved past the scanning device.

42. The method according to claim 32, comprising providing the transport device with an identifier in which the destination of the transport device is stored, the identifier being detected by a separate scanner of the scanning device while being moved past said scanning device.

43. The method according to claim 32, comprising manually entering the destination of the transport device before or after each time the transport device is moved past the scanning device.

44. The method according to claim 32, the destination of the transport device is permanently stored in an evaluation unit.

45. The method according to claim 32, wherein the objects can be of different sizes, each identifier contains information about size of the individual objects and the information about the size detected by the scanning device is transmitted to an evaluation unit for processing.

46. The method according to claim 32, wherein all of the objects are of the same size and the size is entered into an evaluation unit and stored there.

47. The method according to claim 32, wherein further operation of the scanning device is blocked upon generation of either the first signal or the second signal.

48. The method according to claim 47, wherein unblocking of the scanning device requires a manual input from a user.

49. The method according to claim 47, wherein unblocking of the scanning device requires that the transport device has to be moved past the scanning device again.

50. The method according to claim 32, comprising generating a log regarding the generation of the first signal and/or the second signal.

51. The method according to claim 32, comprising transmitting the detected destination of each of the one or more objects to a central administration system.

52. The method according to claim 32, wherein the objects are essentially cube-shaped containers.

53. The method according to claim 32, wherein the objects are containers that are adapted to hold mailpieces.

54. The method according to claim 32, wherein the transport device comprises a transport cart.

55. A device for checking the loading of a transport device that is loaded with one or more objects, each of the objects being provided with an optically detectable identifier, the device comprising:
a housing with a plurality of scanners arranged one above the other;
a detector that is adapted to read a destination of the transport device;
an evaluation unit that is adapted to receive and evaluate information detected by the plurality of scanners, the evaluation unit having a processor that is adapted to compare detected destinations of the objects to the destination of the transport device;
an alarm that is adapted to generate a first signal if a comparison has revealed that the detected destination of one or more of the objects does not match the destination of the transport device;
a plurality of light barriers arranged one above the other, whereby the number of light barriers is at least equal to the number of plurality of scanners;
a device that is adapted to detect the size of the objects, the evaluation unit being adapted to compare a loading height of the objects detected with the light barriers to the size of the objects; and
an alarm that is adapted to generate a second signal if the comparison of the loading height of the objects to the size of the objects indicates that one or more of the objects has an unreadable identifier or no identifier at all.

56. The device according to claim 56, wherein:
the scanning device is connected to a display device; and
the evaluation unit is adapted to ascertain and display on the display device an indication of an object whose destination does not match the destination of the transport device and/or that has an unreadable identifier or no identifier at all.

57. The device according to claim 55, wherein the scanning device has spacers for moving the transport device past, at a predetermined distance from the housing of the device.

58. The device according to claim 57, wherein the spacers comprise an elongated collision guard that is arranged at a distance from the housing and along which the transport device is pulled manually.

59. The device according to claim 57, wherein the spacers comprise two guide grooves arranged at a distance from the housing, and wherein wheels of the transport device are adapted to be manually pulled through the grooves.

60. The device according to claim 55, wherein the detector that is adapted to detect the destination of the transport device comprises a separate scanner that is located on the housing or that is configured as a portable component separate from the housing.

61. A system that is adapted to check the loading of a transport device, the transport device being adapted to be loaded with one or more objects that each have an optically detectable identifier that is adapted to store at least information about a destination of the respective object, the system comprising:
means for detecting a destination of the transport device;
means for moving the transport device, together with the one or more objects, past a scanning device that is adapted to detect the information stored on the identifiers of the objects, the scanning device having at least two scanners arranged one above the other;
means for detecting a loading height of the objects when the transport device is moved past the scanning device;
means for detecting the destination of the one or more objects from their respective identifiers;
means for comparing the detected destination of each of the one or more objects with the destination of the transport device;
means for comparing the detected loading height to previously stored information about the sizes of the objects corresponding to the identifiers scanned by the scanning unit;
means for generating a first signal if the destination of any object does not match the destination of the transport device; and
means for generating a second signal if a plausibility check reveals that an object with an unreadable identifier or with no identifier at all is positioned in an area of the transport device.
